(19) United States
(12) Patent Application Publication
(10) Pub. No.: US 2020/0346407 A1
(43) Pub. Date: Nov. 5, 2020

(54) ADDITIVE MANUFACTURING SYSTEM WITH ROTARY POWDER BED

(71) Applicant: NIKON CORPORATION, Tokyo (JP)

(72) Inventors: Eric Peter Goodwin, Oro Valley, AZ (US); Johnathan Agustin Marquez, San Diego, CA (US); Michael Birk Binnard, Belmont, CA (US); Brett Herr, Menlo Park, CA (US); Matthew Parker-McCormick Bjork, Oakland, CA (US); Paul Derek Coon, Redwood City, CA (US); Patrick Chang, San Mateo, CA (US); Motofusa Ishikawa, Tokyo (JP)

(21) Appl. No.: 16/957,957

(22) PCT Filed: Dec. 22, 2018
(86) PCT No.: PCT/US18/67407

§ 371 Date: Jun. 25, 2020

Related U.S. Application Data
(60) Provisional application No. 62/611,927, filed on Dec. 29, 2017.
(60) Provisional application No. 62/611,416, filed on Dec. 28, 2017.

(51) Int. Cl. B29C 64/268; B29C 64/241; B29C 64/153; B29C 64/245; B29C 64/255; B29C 64/314; B29C 64/205; B29C 64/236; B29C 64/277

(52) U.S. Cl. CPC B29C 64/268; B29C 64/241; B29C 64/153; B29C 64/245; B33Y 30/00; B29C 64/314; B29C 64/205; B29C 64/236; B29C 64/277; B29C 64/255

(57) ABSTRACT

A processing machine (10) for building a part (11) includes: a support device (26) including a support surface (26B); a drive device (28) which moves the support device (26) so as a specific position on the support surface (26B) is moved along a moving direction (25); a powder supply device (18) which supplies a powder (12) to the moving support device (26) to form a powder layer (13); an irradiation device (22) which irradiates at least a portion of the powder layer (13) with an energy beam (22D) to form at least a portion of the part (11) from the powder layer (13) during a first period of time; and a measurement device (20) which measures at least portion of the part (11) during a second period of time. The first period in which the irradiation device (22) irradiates the powder layer (13) with the energy beam (22D) and the second period in which the measurement device (22) measures are overlapped.

### RELATED APPLICATIONS

This application claims priority on U.S. Provisional Application No. 62/611,416 filed on Dec. 28, 2017, and entitled “THREE DIMENSIONAL PRINTER WITH ROTARY POWDER BED”. This application also claims priority on U.S. Provisional Application No. 62/611,927 filed on Dec. 29, 2017, and entitled “SPINNING BEAM COLUMN FOR THREE DIMENSIONAL PRINTER”. As far as permitted, the contents of U.S. Provisional Application Nos. 62/611,416 and 62/611,927 are incorporated herein by reference.

### BACKGROUND

Current three dimensional printing systems are limited in either the size of the printed parts (too large of a moving mass) or the speed at which parts may be made, or both. Stated in another fashion, current three dimensional printing systems are relatively slow, have a low throughput, are expensive to operate, and may only make relatively small parts.

As a result thereof, there is a never ending search to increase the throughput and reduce the cost of operation for three dimensional printing systems.

### SUMMARY

The present embodiment is directed to a processing machine for building a part. In one embodiment, the processing machine includes: (i) a support device having a support surface; (ii) a drive device which moves the support device so as a specific position on the support surface is moved along a moving direction; (iii) a powder supply device which supplies a powder to the moving support device to form a powder layer; (iv) an irradiation device which irradiates at least a portion of the powder layer with an energy beam to form at least a portion of the part from the powder layer during a first period of time; and (v) a measurement device which measures at least portion of the part during a second period of time. In this embodiment, at least a portion of the first period in which the irradiation device irradiates the powder layer with the energy beam and at least a portion of the second period in which the measurement device measures are overlapped.

As an overview, because the first period and the second period are at least partly overlapping, multiple operations are occurring simultaneously and each part may be made faster and more efficiently.

The measurement device may measure at least a portion of the powder layer during the second period of time.

The irradiation device may sweep the energy beam along a sweep direction which crosses to a moving direction of the support surface.

The moving direction of the support device may include a rotation direction about a rotation axis. Further, the rotation axis may pass through the support surface.

The irradiation device may sweep the energy beam along a direction crossing to the rotation direction.

The irradiation device may be arranged at a position away from the rotation axis along an irradiation device direction that crosses the rotation direction.

The measurement device may be arranged at a position away from the rotation axis along a measurement device direction that crosses the rotation direction.

The irradiation device may be arranged at a position which is away from the rotation axis along an irradiation device direction that crosses the rotation direction and which is spaced apart from the measurement device along the rotation direction.

Additionally, the processing machine may include a pre-heat device which pre-heats the powder in a pre-heat zone that is positioned away from an irradiation zone where the energy beam by the irradiation device is directed at the powder along the moving direction. In one embodiment, the pre-heat device is arranged between the powder supply device and the irradiation device along the moving direction.

In one embodiment, at least part of the first period and at least part of a third period in which the pre-heat device pre-heats the powder are overlapped. Additionally, or alternatively, at least part of the second period and at least part of the third period in which the pre-heat device pre-heats the powder are overlapped.

The irradiation device may include a plurality of irradiation systems which irradiate the powder layer with the energy beam. In one embodiment, the plurality of irradiation systems are arranged along a direction crossing to the moving direction.

In one embodiment, the powder is cooled in a cooling zone away from an irradiation zone irradiated with the energy beam by the irradiation device along the moving direction. The cooling zone where the powder cools may be arranged between the irradiation device and the powder supply device along the moving direction.

The support surface may include a plurality of support regions. In this embodiment, a separate part may be made in each support region. Moreover, the plurality of support regions may be arranged along the moving direction. The support surface may face a first direction, and the drive device may drive the support device so as to move the specific position on the support surface along a second direction crossing to at least the first direction.

The powder supply device may form a layer of a powder along a surface crossing to the first direction.

In one embodiment, at least part of the first period and at least part of a third period in which the powder supply device forms the powder layer are overlapped. Additionally, or alternatively, at least part of the third period and at least part of a fourth period in which the pre-heat device pre-heats the powder are overlapped. Additionally, or alternatively, at least part of the second period and at least part of a third period in which the powder supply device deposits/forms the powder layer are overlapped.

In one embodiment, the irradiation device irradiates the layer with a charged particle beam.

In another embodiment, the processing machine includes: (i) a support device having a support surface; (ii) a drive device which drives the support device so as to move a specific position on the support surface along a moving direction; (iii) a powder supply device which supplies a powder to the support device which is moving to form a powder layer; and (iv) an irradiation device which irradiates the powder layer with an energy beam to form a built part from the powder layer. In this embodiment, the irradiation device changes an irradiation position where the energy beam is irradiated to the powder layer along a direction crossing to the moving direction.

The drive device may drive the support device so as to rotate about a rotation axis, and the irradiation device changes the irradiation position along a direction crossing to the rotation axis.

In yet another embodiment, the processing machine includes: (i) a support device including a support surface; (ii) a drive device which drives the support device so as to move a specific position on the support surface along a moving direction; (iii) a powder supply device which supplies a powder to the support device which is moving, and forms a powder layer; and (iv) an irradiation device includes a plurality of irradiation systems which irradiate the layer with an energy beam to form a built part from the powder layer. In this embodiment, the irradiation systems are arranged along a direction crossing to the moving direction.

The drive device may drive the support device so as to rotate about a rotation axis, and the irradiation systems may be arranged along a direction crossing to the rotation axis.

Still another embodiment is directed to an additive manufacturing system for making a three dimensional object from powder. In this embodiment, the additive manufacturing system includes: (i) a powder bed; (ii) a powder depositor that deposits the powder onto the powder bed; and (iii) a mover that rotates at least one of the powder bed and the powder depositor while the powder depositor deposits the powder onto the powder bed.

For example, the mover may rotate the powder bed relative to the powder depositor while the powder depositor deposits the powder onto the powder bed.

The additive manufacturing system may include an irradiation device that generates an irradiation beam that is directed at the powder on the powder bed to fuse at least a portion of the powder together to form at least a portion of the three dimensional object. In this embodiment, the mover may rotate the powder bed relative to the irradiation device. The irradiation device may include an irradiation source that is scanned radially relative to the powder bed.

In one embodiment, the powder depositor may be moved transversely to the rotating powder bed. For example, the powder depositor may be moved linearly across the rotating powder bed.

The additive manufacturing system may include a pre-heat device that preheats the powder. In this embodiment, the mover may rotate the powder bed relative to the pre-heat device.

The mover may rotate the powder bed at a substantially constant angular velocity while the powder depositor deposits the powder onto the powder bed.

In one embodiment, the powder bed includes a curved support surface that is curved to match the shape of the irradiation beam.

In yet another embodiment, the additive manufacturing system includes: a material bed; a material depositor that deposits molten material onto the material bed to form the object; and a mover that rotates at least one of the material bed and the material depositor about a rotation axis while the material depositor deposits the molten material onto the material bed.

In still another embodiment, the present embodiment is directed to a processing machine for building a part that includes (i) a support device including a support surface; (ii) a drive device which moves the support device so a specific position on the support surface is moved along a moving direction; (iii) a powder supply device which supplies a powder to the moving support device to form a powder layer during a powder supply time; and (iv) an irradiation device which irradiates at least a portion of the powder layer with an energy beam to form at least a portion of the part from the powder layer during an irradiation time; and wherein at least part of the powder supply time and the irradiation time are overlapped.

The irradiation device may sweep the energy beam along a sweep direction which crosses a moving direction of the support surface. The moving direction of the support device may include a rotation direction about a rotation axis. The rotation axis may pass through the support surface. The irradiation device may sweep the energy beam along a direction crossing the rotation direction. The irradiation device may be positioned away from the rotation axis along an irradiation device direction that crosses the rotation direction. The measurement device may be positioned away from the rotation axis along a measurement device direction that crosses the rotation direction. The irradiation device may be positioned away from the rotation axis along an irradiation device direction that crosses the rotation direction and which is spaced apart from the measurement device along the rotation direction. Additionally, the processing machine may include a pre-heat device which pre-heats a powder in a pre-heat zone that is positioned away from an irradiation zone where the energy beam by the irradiation device is directed at the powder along the moving direction.

In another embodiment, the processing machine includes: a support device including a non-flat support surface; a powder supply device which supplies a powder to the support device and which forms a curved powder layer; and an irradiation device which irradiates the layer with an energy beam to form a built part from the powder layer. In one version, the non-flat support surface having a curvature. The irradiation device may sweep the energy beam along swept direction, and wherein the curved support surface includes a curvature in a plane where the energy beam pass through.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified side view of an embodiment of a processing machine having features of the present embodiment;

FIG. 1B is a simplified top view of a portion of the processing machine of FIG. 1A;

FIG. 2 is a simplified side view of another embodiment of a processing machine having features of the present embodiment;

FIG. 3 is a simplified top view of a portion of another embodiment of a processing machine having features of the present embodiment;

FIG. 4 is a simplified top view of a portion of still another embodiment of a processing machine having features of the present embodiment;

FIG. 5 is a simplified top view of a portion of yet another embodiment of a processing machine having features of the present embodiment;

FIG. 6 is a simplified side view of a portion of another embodiment of a processing machine having features of the present embodiment;

FIG. 7A is a simplified side view of a portion of yet another embodiment of a processing machine having features of the present embodiment;

FIGS. 7B and 7C are top views of alternative powder beds;

FIG. 8 is a simplified side view of a portion of still another embodiment of a processing machine having features of the present embodiment; and

FIG. 9 is a simplified side view of a portion of still another embodiment of a processing machine having features of the present embodiment.

### DESCRIPTION

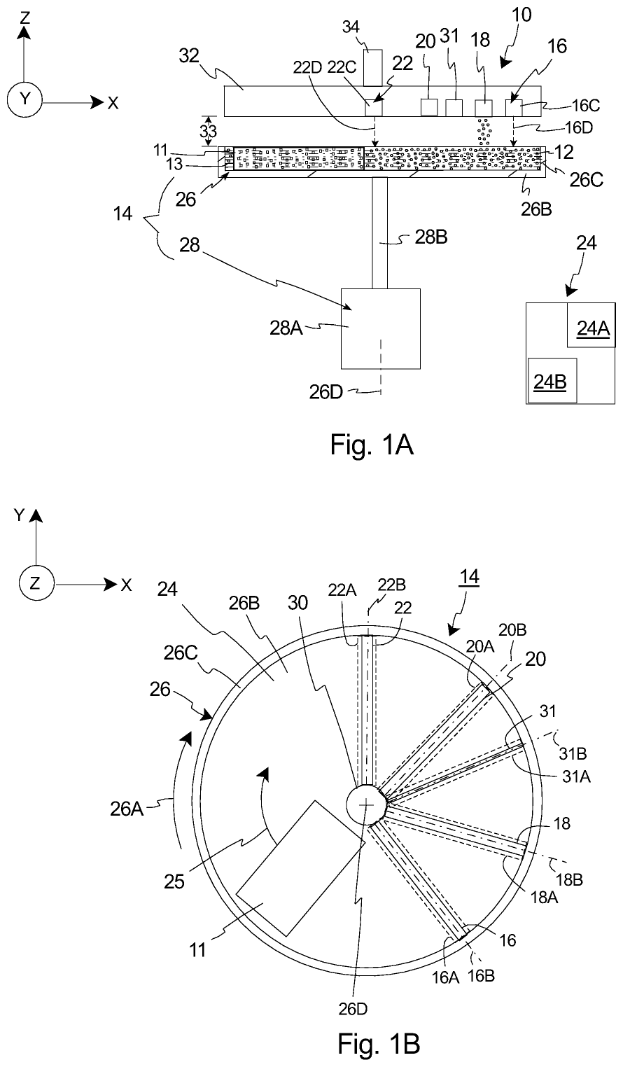

FIG. 1A is a simplified side view of an embodiment of a processing machine 10 that may be used to manufacture one or more three-dimensional objects 11 (illustrated as a box). As provided herein, the processing machine 10 may be an additive manufacturing system such as a three dimensional printer in which powder 12 (illustrated as small circles) is joined, melted, solidified, and/or fused together in a series of powder layers 13 (illustrated as dashed horizontal lines) to manufacture one or more three-dimensional object(s) 11. In FIG. 1A, the object 11 includes a plurality of small squares that represent the joining of the powder layers 13 to form the object 11.

The type of three dimensional object(s) 11 manufactured with the processing machine 10 may be almost any shape or geometry. As a non-exclusive example, the three dimensional object 11 may be a metal part, or another type of part, for example, a resin (plastic) part or a ceramic part, etc. The three dimensional object 11 may also be referred to as a “built part”.

The type of powder 12 joined and/or fused together may be varied to suit the desired properties of the object(s) 11. As a non-exclusive example, the powder 12 may include powder grains for metal three-dimensional printing. Alternatively, the powder 12 may be medal powder, non-metal powder, a plastic, polymer, glass, ceramic powder, or any other material known to people skilled in the art. The powder 12 may also be referred to as “material”.

In certain embodiments, the processing machine 10 includes (i) a powder bed assembly 14; (ii) a pre-heat device 16 (illustrated as a box); (iii) a powder supply device 18 (illustrated as a box); (iv) a measurement device 20 (illustrated as a box); (v) an irradiation device 22 (illustrated as a box); and (vi) a control system 24 that cooperate to make each three-dimensional object 11. The design of each of these components may be varied pursuant to the teachings provided herein. It should be noted that the positions of the components of the processing machine 10 may be different than that illustrated in FIG. 1A. Further, it should be noted that the processing machine 10 may include more components or fewer components than illustrated in FIG. 1A.

FIG. 1B is a simplified top view of a portion of the powder bed assembly 14 of FIG. 1A and the three dimensional object 11. FIG. 1B also illustrates (i) the pre-heat device 16 (illustrated as box) and a pre-heat zone 16A (illustrated with dashed lines) which represents the area in which the powder 12 is being pre-heated with the pre-heat device 16; (ii) the powder supply device 18 (illustrated as a box) and a deposit zone 18A (illustrated in phantom) which represents the area in which the powder 12 is being added to the powder bed assembly 14 by the powder supply device 18; (iii) the measurement device 20 (illustrated as a box) and a measurement zone 20A (illustrated in phantom) which represents the area in which the powder 12 and/or the object 11 is being measured by the measurement device 20; and (iv) the irradiation device 22 (illustrated as a box) and an irradiation zone 22A which represents the area in which the powder 12 is irradiated and fused together by the irradiation device 22. It should be noted that these zones may be spaced apart different from the non-exclusive example illustrated in FIG. 1B.

As an overview, with reference to FIGS. 1A and 1B, in certain embodiments, the processing machine 10 is uniquely designed so that there is substantially constant relative motion along a moving direction 25 (illustrated by an arrow) between the object 11 being formed and each of the pre-heat device 16, the powder supply device 18, the measurement device 20, and the irradiation device 22. The moving direction 25 may include a rotation direction about a support rotation axis 26D. With this design, the powder 12 may be deposited and fused relatively quickly. This allows for the faster forming of the objects 11, increased throughput of the processing machine 10, and reduced cost for the objects 11.

A number of different designs of the processing machine 10 are provided herein. In the embodiment illustrated in FIGS. 1A and 1B, the powder bed assembly 14 includes (i) a support device 26 that supports the powder 12 and the object 11 while being formed, and (ii) a device mover 28 (e.g. one or more actuators) that selectively moves the support device 26 along a support movement direction 26A relative to the pre-heat device 16 (and the pre-heat zone 16A), the powder supply device 18 (and the deposit zone 18A), the measurement device 20 (and the measurement zone 20A), and the irradiation device 22 (and the irradiation zone 22A). With this design, the device mover 28 moves the support device 26 so a specific position on the support device 26 is moved along the support movement direction 26A. The device mover 28 may move at least one of the pre-heat device 16 (and the pre-heat zone 16A), the powder supply device 18 (and the deposit zone 18A), the measurement device 20 (and the measurement zone 20A), and the irradiation device 22 (and the irradiation zone 22A) relative to the support device along the movement direction 26A.

It should be noted that the processing machine 10 may be operated in a vacuum environment. Alternatively, the processing machine 10 may be operated in non-vacuum environment such as inert gas (e.g. nitrogen gas or argon gas) environment.

In one embodiment, the support device 26 is moved (e.g. rotated) at a constant radial velocity relative to the pre-heat device 16, the powder supply device 18, the measurement device 20, and the irradiation device 22. This allows nearly all of the rest of the components of the processing machine 10 to be fixed while the support device 26 is moved. Because, the support device 26 is constantly moving, the object 11 may be made faster. In this embodiment, the problem of too many moving parts, large forces and slow layer deposition for powder 12 on the support device 26 is solved by utilizing a rotary support device 26. The radial velocity of the support device 26 may be a constant velocity.

In the simplified schematic illustrated in FIGS. 1A and 1B, the support device 26 includes a support surface 26B and a support side wall 26C. In this embodiment, the support surface 26B is flat disk shaped, and the support side wall 26C is tubular shaped and extends upward from a perimeter of the support surface 26B. Alternatively, other shapes of the support surface 26B and the support side wall 26C may be utilized. It should be noted that the support device 26 is illustrated as a cut-away in FIG. 1A. In some embodiments, the support surface 26B moves as a piston relative to the support side wall 26C which act like as the piston's cylinder wall. The shape of the support surface 26B may not be a circle shape, it may be a rectangle shape or polygonal shape. Further, the shape of the support side wall 26C may not be a tubular shaped, it may be a rectangle pillar shaped or polygonal pillar shaped.

The device mover 28 may move the support device 26 at a substantially constant or variable angular velocity along the support movement direction 26A. As alternative, non-exclusive examples, the device mover 28 may move the support device 26 at a substantially constant angular velocity of at least approximately 2, 5, 10, 20, 30, 60, or more revolutions per minute (RPM) along the support movement direction 26A. As used herein, the term “substantially constant angular velocity” shall mean a velocity that varies less than 5% over time. In one embodiment, the term “substantially constant angular velocity” shall mean a velocity that varies less 0.1% from the target velocity. The device mover 28 may also be referred to as a “drive device”.

In one embodiment, the device mover 28 rotates the support device 26, in a rotational direction (e.g. the support movement direction 26A) that has the support rotation axis 26D (e.g. about the Z axis in FIG. 1A) that passes through the support surface 26B. Additionally or alternatively, the device mover 28 may move the support device 26 at a variable velocity or in a stepped or other fashion. The support rotation axis 26D may be aligned along with gravity direction, and may be along with an inclination direction about the gravity direction.

In FIG. 1A, the device mover 28 includes a motor 28A (i.e. a rotary motor) and a device connector 28B (i.e. a rigid shaft) that fixedly connects the motor 28A to the powder bed 26. In other embodiments, the device connector 28B may include a transmission device such as at least one gear, belt, chain, or friction drive.

In one embodiment, the support surface 26A faces in a first direction (e.g. along the Z axis), and the device mover 28 drives the support device 26 so as to move the specific position on the support surface 26A along a second direction (e.g. the support movement direction 26A) crossing the first direction.

The powder 12 used to make the object 11 is deposited onto the support device 26 in a series of powder layers 13. Depending upon the design of the processing machine 10, the support device 26 with the powder 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. With the present design, rotary motion of the powder bed 26 eliminates the need for linear motors to move the powder bed 26. The exposure process may performed during the period when the motion is constant velocity motion.

In one embodiment, the powder bed 26 either has an axis in the center, or at least a “no-print” zone 30 (illustrated as a circle), such that parts 11 may either be very large (the diameter of the powder bed) with the restriction that they have a hollow center, or they must be smaller than the radius of the powder bed 26. Alternatively, the powder bed 26 may be moved to eliminate the no-print zone 30. For example, the axis 26D of the powder bed 26 may be arranged away from the center.

The pre-heat device 16 selectively preheats the powder 12 in the pre-heat zone 16A that has been deposited on the support device 26 during a pre-heat time. Stated in another fashion, the pre-heat device 16 may be used to bring the powder 12 in the powder bed 26 up to a desired preheated temperature. In certain embodiments, the pre-heat device 16 heats the powder 12 in the pre-heat zone 16A when the object 11 being built is moved through the pre-heat zone 16A.

In one embodiment, the pre-heat device 16 extends along a pre-heat axis (direction) 16B and is arranged between the powder supply device 18 and the irradiation device 22 along the movement direction 26A. Further, the pre-heat axis 16B crosses the movement direction 26A and is transverse to the rotation axis 26D. With this design, the pre-heat zone 16A is positioned between the deposit zone 18A and the irradiation zone 22A, and the pre-heat device 16 may pre-heat the powder 12 in the pre-heat zone 16A away from the irradiation zone 22A along the moving direction 25. In FIG. 1B the pre-heat zone 16A is illustrated far from the irradiation zone 22A. However, the relative positioning of these zones 16A, 22A may be different than that illustrated in FIG. 1B. Additionally the relative sizes of the zones 16A, 22A may be different than what is illustrated in FIG. 1B. For example, the pre-heat zone 16A may be much larger than the irradiation zone 22A. For example, these zones 16A, 22A may be adjacent to each other. The number of the pre-heat device 16 may be one or plural.

The design of the pre-heat device 16 and the desired preheated temperature may be varied. In one embodiment, the pre-heat device 16 may include one or more pre-heat energy source(s) 16C that direct one or more pre-heat beam(s) 16C at the powder 12. If one pre-heat source 16C is utilized, the pre-heat beam 16D may be steered radially along the pre-heat axis 16B to heat the powder 12 in the pre-heat zone 16A. Alternatively, multiple pre-heat sources 16C may be positioned to heat the pre-heat zone 16A. As alternative, non-exclusives examples, each pre-heat energy source 16C may be an electron beam system, a mercury lamp, an infrared laser, a supply of heated air, thermal radiation system, a visual wavelength optical system or a microwave optical system. The desired preheated temperature may be 50% 75% 90% or 95% of the melting temperature of the powder material used in the printing. It is understood that different powders have different melting points and therefore different desired pre-heating points. As non-exclusive example, the desired preheated temperature may be at least 300, 500, 700, 900, or 1000 degrees Celsius. The pre-heat axis 16B may not be one straight line.

The powder supply device 18 deposits the powder 12 onto the support device 26 during a deposit time (also referred to as “powder deposition time”). In certain embodiments, the powder supply device 18 supplies the powder 12 to the support device 26 positioned in the deposit zone 18A while the support device 26 is being rotated to form a powder layer on the support device 26. In one embodiment, the powder supply device 18 extends along a powder supply axis (direction) 18B and is arranged between the measurement device 20 and the pre-heat device 16 along the movement direction 26A. Further, the powder supply axis 18B crosses the movement direction 26A and is transverse to the rotation axis 26D. In one embodiment, the powder supply device 18 includes one or more reservoirs (not shown) which retain the powder 12 and a powder mover (not shown) that moves the powder 12 from the reservoir(s) to the deposit zone 18A above the support device 26. The powder supply axis 18B may not be one straight line. The number of the powder supply device 18 may be one or plural.

With the present design, the powder supply device 18 forms an individual layer 13 of a powder 12 along the support surface 26B of the powder bed 26 during each rotation, and the support surface 26B crosses the support moving direction 26A and the support rotation axis 26D.

Once a layer of powder 12 has been melted with the irradiation device 22, it is necessary to deposit another (subsequent) layer 13 of powder 12, as evenly and uniformly as possible with the powder supply device 18. In the case of a rotating support device 26, the deposition may take place at multiple different locations with multiple spaced apart powder depositors 18 being utilized.

The measurement device 20 inspects and monitors the melted (fused) layer and the deposition of the powder 12 in the measurement zone 18A during a measurement time. Stated in another fashion, the measurement device 20 measures at least a portion of the powder 12 and a portion of the part 11 while the support device 26 and the powder 12 are being moved. In one embodiment, the measurement device 20 is arranged at a position away from the rotation axis 26D along a measurement device axis (direction) 20B that crosses the rotation direction 26D. The measurement device 20 may inspect at least portion of the powder layer only, may inspect at least portion of the part 11 only, or both. The number of the measurement devices 20 may be one or plural. The measurement device axis 20B may not be one straight line. In this design, the measurement device 20 is arranged between the irradiation device 22 and the powder supply device 18 (upstream of the powder supply device), however, the measurement device 20 may be arranged downstream of the powder supply device 18 along the moving direction 26A, may be arranged between the powder supply device 18 and the pre-heat device 16, or may be arranged downstream of the pre-heat device 16. The measurement device 20 may inspect at least one of powder layer 13 or build part by way of optically, electrically, or physically.

As non-exclusive examples, the measurement device 20 may include one or more optical elements such as a uniform illumination device, fringe illumination device, cameras that function at one or more wavelengths, lens, interferometer, or photodetector, or a non-optical measurement device such as an ultrasonic, eddy current, or capacitive sensor.

The irradiation device 22 selectively heats and melts the powder 12 in the irradiation zone 22A that has been deposited on the support device 26 to form the object 11 during an irradiation time. More specifically, the irradiation device 22 sequentially exposes the powder 12 to sequentially form each of the layers 13 of the object 11 while the powder bed 26 and the object 11 are being moved. The irradiation device 22 selectively irradiates the powder 12 at least based on a data regarding to an object 11 to be built. The data may be corresponding to a computer-aided design (CAD) model data. The number of the irradiation devices 22 may be one or plural.

In one embodiment, the irradiation device 22 extends along an irradiation axis (direction) 22B and is arranged between the pre-heat device 16 and the measurement device 20 along the movement direction 26A. Further, the irradiation axis 22B crosses the movement direction 26A and is transverse to the rotation axis 26D. The design of the irradiation device 22 and the desired irradiation temperature may be varied. In one embodiment, the irradiation device 22 may include one or more irradiation energy source(s) 22C (“irradiation systems”) that direct one or more irradiation (energy) beam(s) 22D at the powder 12. If one irradiation energy source 22C is utilized, the irradiation beam 22D may be steered radially to irradiate the powder irradiation zone 22A. With this design, the irradiation device 22 may be controlled to sweep the energy beam 22D along a sweep direction (e.g. along the irradiation axis 22B) which crosses to the moving direction 25 of the support surface 26B. Alternatively, multiple energy sources 22C may be positioned to irradiate the irradiation zone 22A along the irradiation axis 22B with each having a separate energy beam 22D. In this embodiment, the plurality of irradiation systems 22C are arranged along a direction (e.g. the irradiation axis 22B) that crossing to the moving direction 26A. The plural irradiation devices (the multiple energy sources 22C) may be arranged along the moving direction 26A or across the moving direction 26A.

As alternative, non-exclusives examples, each of the irradiation energy sources 22C may be an electron beam system that generates a charged particle beam, a laser beam system that generates a laser beam, an electron beam, an ion beam system that generates a charged particle beam, or an electric discharge arc, and the desired irradiation temperature may be at least 1000, 1400, 1700, 2000, or more degrees Celsius. In another embodiment, each of the irradiation energy sources 22C may be designed to generate a charged particle beam, an infrared light beam, a visual beam or a microwave beam, and the desired irradiation temperature may be at least 50% 75% 90% or 95% of the melting temperature of the powder material used in the printing. It is understood that different powders have different melting points and therefore different desired pre-heating points. The irradiation energy sources 22C can be a laser beam system that generates a laser beam.

As provided herein, the irradiation device 22 may arranged at a position away from the rotation axis 26D along an irradiation device direction (e.g. the irradiation axis 22B) that crosses the rotation direction 26A. Further, the irradiation device 22 is spaced apart from the measurement device 22 along the rotation direction 26A.

The control system 24 controls the components of the processing machine 10 to build the three dimensional object 11 from the computer-aided design (CAD) model by successively adding powder 12 layer by layer. The control system 24 may include one or more processors 24A and one or more electronic storage devices 24B.

The control system 24 may include, for example, a CPU (Central Processing Unit), a GPU (Graphics Processing Unit), and a memory. The control system 24 functions as a device that controls the operation of the processing machine 10 by the CPU executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU may be recorded in a memory (that is, a recording medium) included in the control system 24, or an arbitrary storage medium built in the control system 24 or externally attachable to the control system 24, for example, a hard disk or a semiconductor memory. Alternatively, the CPU may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications (cable communications), a wireless communications, or a network. In case of physically connecting with wired, it is possible to use serial connection or parallel connection of IEEE1394, RS-232x, RS-422, RS-423, RS-485, USB, etc. or 10 BASE-T, 100 BASE-TX, 1000 BASE-T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD−R, a DVD+R, a DVD−RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

Additionally, optionally, the processing machine 10 may include a cooler device 31 (illustrated as a box) that cools the powder 12 on the powder bed 26 in a cooler zone 31A (illustrated in phantom) after fusing with the irradiation device 22. In one embodiment, the cooler device 31 extends along a cooler axis 31B and is arranged between the measurement device 20 and the powder supply device 18 along the movement direction 26A. With this design, the cooler device 31 cools the powder 12 in the cooler zone 31A away from the irradiation zone 22A along the moving direction 26A. Further, the cooler zone 31A may be arranged between the irradiation zone 22A of irradiation device 22 and the supply zone 18A of the powder supply device 15 along the moving direction 26A. The cooler axis 31B may not be one straight line.

As non-exclusive examples, the cooler device 31 may utilize radiation, conduction, and/or convection to cool the newly melted material (e.g., metal) to a desired temperature.

In the non-exclusive example in FIG. 1A, the pre-heat device 16, the powder depositor 18, the measurement device 20, the irradiation device 22, and the cooler device 31 may be fixed together and retained by a common component housing 32. Collectively these components may be referred to as the top assembly. Alternatively, one or more of these components may be retained by one or more separate housings. In this design, the common component housing 32 may be rotated along the moving direction 26A or an opposite direction of the moving direction 26A. At this situation, the support device 26 may be fixed or may be moved (rotated) along the moving direction. At least one of the pre-heat device 16, the powder depositor 18, the measurement device 20, the irradiation device 22, and the cooler device 31 may be movable in a direction crossing to the moving direction 26A.

With reference to FIGS. 1A and 1B, the support bed 26 may be referenced as a clock face for ease of discussion. In this embodiment, at 12 o'clock, the exposure takes place using the irradiation device 22. Note the local rate of travel of the support bed 26 will be faster at the edge than at the center, so adjustments in the positioning of the multiple irradiation energy sources 22B may be needed. A suitable rotation angle away, say at 1:30 on the clock face, the measurement with the measurement device 20 (illustrated in FIG. 1A) may take place. The measurement device 20 only needs to span the radius of the powder bed 26, rather than the full area of the powder bed 12 in other methods.

At about 2:30, the cooler device 31 may cool the powder 12 on the powder bed 26. At about 3:15, the powder depositor 18 may be positioned to deposit the powder 12 onto the powder bed 26. Excess powder 12 may be driven off the edge of the rotary powder bed 26 via centrifugal forces or by the design of the powder depositor 18. In certain embodiments, the deposition rate of the powder depositor 18 is radially dependent. If desired, metrology of deposition may be added, followed by a supplemental powder deposition system that could use feedback from the powder metrology system to selectively add or remove powder where needed.

Next, at about 5 o'clock, the pre-heating with the pre-heat device 16 may occur.

As provided above, (i) the pre-heat device 16 preheats the powder 12 in the pre-heat zone 16A during the pre-heat time; (ii) the powder depositor 18 deposits the powder 12 onto the powder bed 26 in the deposit zone 18A during the deposit time; (iii) the measurement device 20 measures the powder 12 in the measurement zone 20A during the measurement time; (iv) the irradiation device 22 irradiates the powder 12 in the irradiation zone 22A during the irradiation time; and (v) the cooler device 31 cools the powder 12 in the cooler zone 31A during the cooler time. It should be noted that any of the pre-heat time, the deposit time, the measurement time, the irradiation time, and/or the cooler time may be referred to as a first period of time, a second period of time, a third period of time, a fourth period of time, and/or a fifth period of time. The number of the pre-heat devices 16, the powder depositors 18, the measurement devices 20, the irradiation devices 22, and the cooler devices 31 may be plural. In this situation, another irradiation device may be positioned at 6:00, another measurement device may be positioned at 7:30, another cooler device may be positioned at 8:30, another powder depositor may be positioned at 9:15, and another pre-heating device may be positioned at 11 o'clock, for example.

It should also be noted that with the unique design provided herein, multiple operations may be performed at the same time (simultaneously) to improve the throughput of the processing machine 10. Stated in another fashion, one or more of the pre-heat time, the deposit time, the measurement time, the irradiation time, and the cooling time may be partly or fully overlapping in time for any given processing of a layer 13 of powder 12 to improve the throughput of the processing machine 10. For example, two, three, four, or all five of these times may be partly or fully overlapping.

More specifically, (i) the pre-heat time may be at least partly overlapping with the deposit time, the measurement time, the irradiation time, and/or the cooling time; (ii) the deposit time may be at least partly overlapping with the pre-heat time, the measurement time, the irradiation time, and/or the cooling time; (iii) the measurement time may be at least partly overlapping with the deposit time, the pre-heat time, the irradiation time, and/or the cooling time; (iv) the irradiation time may be at least partly overlapping with the deposit time, the measurement time, the pre-heat time, and/or the cooling time; and/or (v) the cooling time may be at least partly overlapping with the pre-heat, the deposit time, the measurement time, and/or the irradiation time.

As a first example, (i) during a first period of time, the irradiation device 22 irradiates the powder layer with the irradiation beam 22C, (ii) during a second period of time, the measurement device 20 measures at least part of the object 11/powder 12, and (iii) the first period of time and the second period of time are at least partly overlapping. Further, during a third period of time, the pre-heat device 16 pre-heats the powder 12, and the third period of time is at least partly overlapping with the first period of time and the second period of time. Alternatively, during the third period of time, the powder depositor 18 deposits the powder 12, and the third period of time is at least partly overlapping with the first period of time and the second period of time. Still alternatively, at least part of the third period and at least part of a fourth period in which the pre-heat device pre-heats the powder may be overlapped.

Additionally, or alternatively, at least part of the second period and at least part of a third period in which the powder supply device forms the powder layer may be overlapped. In certain embodiments for maximum throughput, the part 11 (or multiple parts 11) cover a maximum area of support surface 26B and all of the deposit time, pre-heat time, measurement time, irradiation time, and cooling time are substantially continuous and simultaneous; i.e., all of the processes of deposition, pre-heat, measurement, irradiation, and cooling are performed concurrently during a maximum amount of the part fabrication time.

In one embodiment, (i) the irradiation device 22 irradiates at least a portion of the powder 12 to form at least a portion of the part 11 from the layer 13 of powder 12 during a first period of time; (ii) the drive device 28 drives the support device 26 so as to move a specific position on the support surface 26B along the moving direction 26A; (iii) the powder supply device 18 supplies the powder 12 to the support device 26 which moves, and forms the powder layer 13; and (iv) the irradiation device 22 irradiates the layer 13 with the energy beam 22D to form the built part 11 from the powder layer 13. In this embodiment, the irradiation device 22 changes an irradiation position where the energy beam 22D is irradiated to the powder layer 13 along a direction (irradiation axis 22B) that crosses to the moving direction 26A. Additionally, the drive device 28 may drive the support device 26 so as to rotate about the rotation axis 26D, and the irradiation device 22 may change the irradiation position along the direction (irradiation axis 22B) orthogonal the rotation axis 26D.

In another embodiment, the processing machine 10 includes: (i) the support device 26 having the support surface 26B; (ii) the drive device 28 which drive the support device 26 so as to move a specific position on the support surface 26B along the moving direction 26A; (iii) the powder supply device 18 which supplies the powder 12 to the support device 26 which moves, and forms the powder layer 13; and (iv) the irradiation device 22 including a plurality of irradiation systems 22C which irradiate the layer 13 with the energy beam 22D to form the built part 11 from the powder layer 13. In this embodiment, the irradiation systems 22C arranged along a direction (e.g. the irradiation axis 22B) crossing to the moving direction 26A.

It should be noted that FIG. 1B illustrates that all of the necessary steps may take place in half of the rotation cycle of the powder bed 26. This means a complete second system (not shown) that includes another pre-heat device, powder depositor, measurement device, and irradiation device could be added on the other half, to allow twice as high a rate of three dimensional printing for the same rotary velocity of the powder bed 26. Further, the arrangement of components could be compressed to add a complete third system (not shown) or more if desired. Alternatively, for a “single system” embodiment the size of the areas 16A, 18A, 20A, 22A, 31A may be increased to cover a greater portion, or substantially all, of the support surface 26B.

It should also be noted that some or all of the above steps are happening simultaneously on different parts of the powder bed 26, so that the duty cycle of three dimensional printing is 100%, and there is one or more of pre-heating, powder depositing, measuring, and/or irradiating happening at all times. Adding the second (or third) printing region pushes the effective duty cycle to 200% (or 300%).

The least efficient way to use this processing machine 10 is to make only one object 11 at a time, that does not utilize the full donut shaped exposure region of the powder bed 26. In this case, the object 11 sequentially goes from exposure to metrology, to deposition to pre-heating, and then repeats. However, even in this least efficient mode of operation, the part fabrication speed is comparable to a more traditional system.

If large parts or multiple parts are made simultaneously, the system may run at almost 100% duty cycle, with some or all stages happening in parallel, resulting in large throughput and tool utilization improvements.

In certain embodiments, the powder bed 26 may be moved down with the device mover 28 along the support rotation axis 26D in a continuous rate via a fine pitch screw or some equivalent method. With this design, a height 33 between the most recent (top) layer of powder 12 and the powder depositor 18 (and other top assembly) may be maintained substantially constant for the entire process. Alternatively, the powder bed 12 may be moved down in a step down fashion at each rotation, which could lead to the possibility of a discontinuity at one radial position in the powder bed 12. As used herein, “substantially constant” shall mean the height 33 varies by less than a factor of three, since the typical thickness of each powder layer is less than one millimeter. In another embodiment, “substantially constant” shall mean the height 33 varies less than ten percent of the height 33 during the manufacturing process.

Still alternatively, the top assembly may include a housing mover 34 that moves the top assembly (or a portion thereof) upward a continuous (or stepped) rate while the powder 12 is being deposited to maintain the desired height. The housing mover 34 may include one or more actuators. The housing mover 34 and/or the device mover 28 may be referred to as a first mover or a second mover.

Although the diameter of the cylindrical powder bed 26 will be much larger than the size of the parts 11 that may be made (except for parts that may have a hole in the center), the size of the rotary powder bed 26 is not that much larger than the size needed for a rectangular powder bed 26 capable of printing the same maximum size. That's because the rotary method has a fixed footprint, while the linear translation of the powder bed requires space on all sides of the exposure region for scanning along a single axis.

As provided herein, in certain embodiments, a non-exclusive example of an advantage of the present embodiment is that the rotary powder bed 26 system provided herein requires primarily only one moving part, the powder bed 26, while everything else (pre-heat device 16, powder supply device 18, measurement device 20, irradiation device 22) are all fixed, making the overall system simpler. Also, the throughput of a rotary based powder bed 26 system is much higher since all steps are performed in parallel rather than serially.

It should be noted that the processing machine 10 illustrated in FIGS. 1A and 1B may be designed so that (i) the powder bed 26 is rotated about the Z axis and moved along the Z axis to maintain the desired height 33; or (ii) the powder bed 26 is rotated about the Z axis, and the component housing 32 and the top assembly are moved along the Z axis only to maintain the desired height 33. In certain embodiments, it may make sense to assign Z movement to one component and rotation to the other.

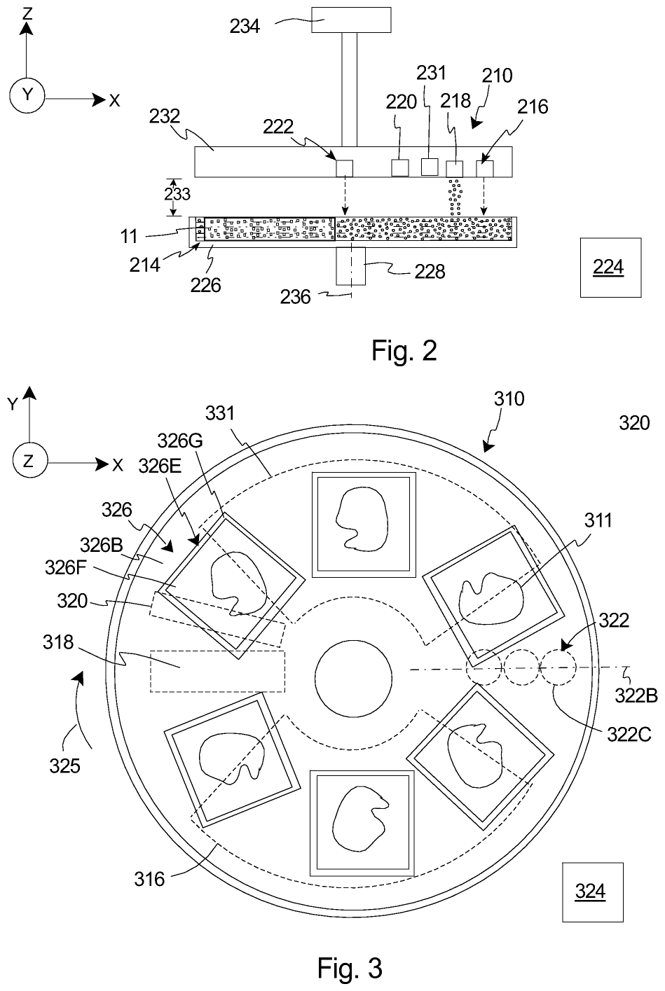

FIG. 2 is a simplified side view of another embodiment of a processing machine 210 for making the object 11. In this embodiment, the three dimensional printer 210 includes (i) a powder bed 226; (ii) a pre-heat device 216 (illustrated as a box); (iii) a powder depositor 218 (illustrated as a box); (iv) a measurement device 220 (illustrated as a box); (v) an irradiation device 222 (illustrated as a box); (vi) a cooler device 231; and (vii) a control system 224 that are somewhat similar to the corresponding components described above. However, in this embodiment, the powder bed 226 of the powder bed assembly 214 is stationary, and the processing machine 210 includes a housing mover 234 that moves the component housing 232 with the pre-heat device 216, the powder depositor 218, the measurement device 220, the irradiation device 222, and the cooler device 231 relative to the powder bed 226.

As a non-exclusive example, the housing mover 234 may rotate the component housing 232 with the pre-heat device 216, the powder depositor 218, the measurement device 220, the irradiation device 222, and the cooler device 231 (collectively “top assembly”) at a constant or variable velocity about a rotation axis 236 (e.g. about the Z axis). Additionally or alternatively, the housing mover 234 may move the component housing 232 with the pre-heat device 216, the powder depositor 218, the measurement device 220, the irradiation device 222, and the cooler device 231 in a stepped fashion along the rotation axis 236.

It should be noted that the processing machine 210 of FIG. 2 may be designed so that (i) the top assembly is rotated about the Z axis and moved along the Z axis to maintain the desired height 233 with the housing mover 234; or (ii) the top assembly is rotated about the Z axis, and the powder bed 226 is moved along the Z axis only with a device mover 228 to maintain the desired height 233. In certain embodiments, it may make sense to assign Z movement to one component and rotation to the other. The housing mover 234 and/or the device mover 238 may be referred to as a first mover or a second mover.

FIG. 3 is a simplified top view of another embodiment of a processing machine 310. In this embodiment, the processing machine 310 is designed to make multiple objects 311 substantially simultaneously. The number of objects 311 that may be made concurrently may vary according the type of object 311 and the design of the processing machine 310. In the non-exclusive embodiment illustrated in FIG. 3, six objects 311 are made simultaneously. Alternatively, more than six or fewer than six objects 311 may be made simultaneously.

In the embodiment illustrated in FIG. 3, each of the objects 311 is the same design. Alternatively, for example, the processing machine 310 may be controlled so that one or more different types of objects 311 are made simultaneously.

In the embodiment illustrated in FIG. 3, the three dimensional printer 310 includes (i) a powder bed 326; (ii) a pre-heat device 316 (illustrated in phantom); (iii) a powder depositor 318 (illustrated in phantom); (iv) a measurement device 320 (illustrated in phantom); (v) an irradiation device 322 (illustrated in phantom); and (vii) a control system 324 that are somewhat similar to the corresponding components described above. However, in this embodiment, the powder bed 326 may include a support surface 326B and a plurality of spaced apart build chambers 326E (e.g. six) that are positioned on and supported by the support surface 326B. In this embodiment, each of the build chambers 326E defines a separate support region 326F with side walls 326G for each separate part 311 that is being made. Further, in this embodiment, the separate build chambers 326E are positioned on the large common support surface 326B. Further, the plurality of build chambers 326E may be arranged along the moving direction 325.

In FIG. 3, a single part 311 is made in each build chamber 326E. Alternatively, more than one part 311 may be built in each build chamber 326E. Similarly, also in the design of FIG. 1, more than one part 11 can be built in the support device 26 substantially simultaneously.

Still alternatively, the support surface 326B of the powder bed 326 may be divided to include the plurality of support regions 326F, with each support region 326F supporting the separate object 311. With this design, the support regions 326F may be adjacent to each other and only physically spaced apart (and not spaced apart with walls) on the common powder bed 326. In this design, the plurality of support regions 326F are also arranged along the moving direction 325.

In one embodiment, the three dimensional printer 310 may be designed so that the powder bed 326 is rotated (e.g. at a substantially constant rate) relative to the pre-heat device 316, the powder depositor 318, the measurement device 320, and the irradiation device 322. In this embodiment, the problem of building a practical and low cost three dimensional printer 310 for high volume three dimensional printing of metal parts 311 is solved by providing a rotating powder bed 326 that supports multiple support regions 326F.

Alternatively, the three dimensional printer 310 may be designed so that pre-heat device 316, the powder depositor 318, the measurement device 320, and the irradiation device 322 are rotated (e.g. at a substantially constant rate) relative to the powder bed 326 and the multiple support regions 326F.

It should be noted that in this embodiment, the irradiation device 322 includes multiple (e.g. three) separate irradiation energy sources 322C that are positioned along the irradiation axis 322B. In this embodiment, each of the energy source 322C generates a separate irradiation beam (not shown). In alternate embodiments, the energy sources 322C may be lasers or electron beams. In the embodiment shown, three energy sources 322C are arranged in a line so that together they may cover the full width of each support region 326F. Because the exposure area covers the entire radial dimension of the desired build volume, every point in the required build volume may be reached by at least one of the energy beams. In an alternative embodiment, where lower throughput is acceptable, a single energy source 322C may be used with the beam being steered in the radial (sweep) direction along the irradiation axis 322B that crosses the rotation axis. In another alternative embodiment, a single energy source 322C with sufficient beam deflection width to cover the desired part radius may expose every point within the build volume.

In some embodiments, for each build chamber 326E, the side walls 326G surrounds an “elevator platform” (support region 326F) that may be moved vertically. Fabrication begins with the elevators (support regions 326) placed near the top of the side walls 326G. The powder depositor 318 deposits a preferably thin layer of metal powder into each build chamber 326E as it is moved (rotated) below the powder depositor 318. At an appropriate time, the elevator platform (support region 326F) in each build chamber 326E is stepped down by one layer thickness so the next layer of powder may be distributed properly.

In some embodiments, a substantially planar surface (not shown) is provided between the side walls 326G of the build chambers 326E to prevent unwanted powder from falling outside the walls 326G. In alternative embodiments, the powder depositor 318 includes features that allow the powder distribution to start and stop at appropriate times so that substantially all of the powder is deposited inside the build chambers 326E.

When a build chamber 326E is full and the part 311 is fully built, the support surface 326B may be momentarily stopped and a robot may exchange the full chamber 326E for an empty one. The full chamber 326E may be moved to a different location for controlled annealing or gradual cooling of the new part(s) 311 while fabrication of new parts 311 is begun in the empty chamber 326E. Depending on the requirements for a particular application, all of the build chambers 326E may be “cycled” at the same time, or the cycling may be staggered to substantially equally spaced times.

In one embodiment, the discrete build chambers 326E may be moved by robot (not shown) (potentially through an airlock) between the rotary turntable and auxiliary chambers where the parts 311 may be slowly cooled in a controlled manner, they may be vented to atmosphere, and/or they may be exchanged with empty build chambers 326E for subsequent fabrication processing.

The shape of each build chamber 326E may be square, rectangular, cylindrical, trapezoidal, or a sector of an annulus.

With the design illustrated in FIG. 3, the three dimensional printer 310 requires no back and forth motion, so throughput may be maximized, and many parts 311 may be built in parallel in the separate build chambers 326E.

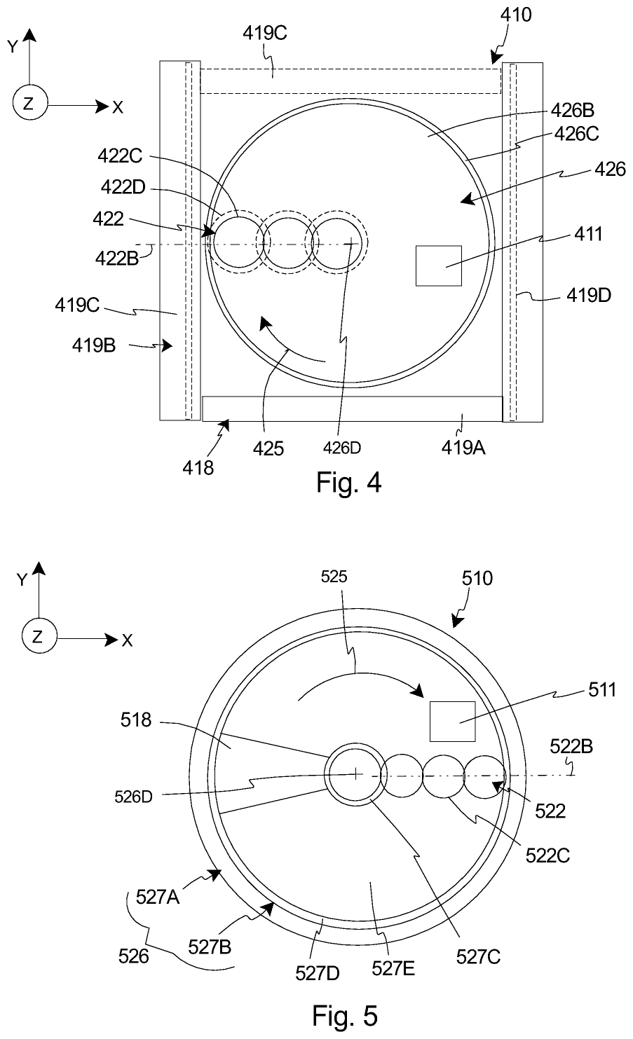

FIG. 4 is a simplified top view of a portion of still another embodiment of a processing machine 410. In this embodiment, the processing machine 410 includes (i) the powder bed 426; (ii) the powder depositor 418; and (iii) the irradiation device 422 that are somewhat similar to the corresponding components described above. It should be noted that the processing machine 410 may include the pre-heat device, the measurement device, the cooler device, and the control system, that have been omitted from FIG. 4 for clarity. The powder depositor 418, the irradiation device 422, the pre-heat device, the cooler device, and the measurement device may collectively be referred to as the top assembly.

In this embodiment, the problem of building a practical and low cost three dimensional printer 410 for three dimensional printing of one or more metal parts 411 (illustrated as a box) is solved by providing a rotating powder bed 426, and the powder depositor 418 is moved linearly across the powder bed 426 as the powder bed 426 is rotated in a moving direction 425 about a rotation axis 426D that is parallel to the Z axis. The part 411 is built in the cylindrical shaped powder bed 426.

In one embodiment, the powder bed 426 includes the support surface 426B having an elevator platform that may be moved vertically along the rotation axis 426D (e.g. parallel to the Z axis), and the cylindrical side wall 426C that surrounds an “elevator platform”. With this design, fabrication begins with the support surface 426B (elevator) placed near the top of the side wall 426C. The powder depositor 418 translates across the powder bed 426 spreading a thin powder layer across the support surface 426B.

In FIG. 4, the irradiation device 422 directs the irradiation beams 422D to fuse the powder to form the parts 411. In this embodiment, the irradiation device 422 includes multiple (e.g. three), separate irradiation energy sources 422C (each illustrated as a solid circle) that are positioned along the irradiation axis 422B. In this embodiment, each of the energy sources 422C generates a separate irradiation beam 422D (illustrated with dashed circle). In the embodiment shown, three energy sources 422C are arranged in a line along the irradiation axis 422B (transverse to the rotation axis 426D) so that together they may cover at least the radius of the support surface 426B. Further, the three energy sources 422C are substantially tangent to each other in this embodiment, and the irradiation beams 422D are overlapping. Because the irradiation beams 422D cover the entire radius of the powder bed 426, every point in the powder bed 426 may be reached by at least one of the irradiation beams 422D. This prevents an exposure “blind spot” at the center of rotation of the powder bed 426.

In an alternative embodiment, where lower throughput is acceptable, a single energy source may be used with the beam being steered in the radial direction to smay in the radial direction. In this embodiment, the beam is scanned parallel to the irradiation axis 422B that is transverse to the rotation axis 426D and that crosses the movement direction. In another alternative embodiment, a single energy source with sufficient beam deflection width to cover the desired part radius may expose every point within the build volume.

The powder depositor 418 distributes the powder across the top of the powder bed 426. In this embodiment, the powder depositor 418 includes a powder spreader 419A and a powder mover assembly 419B that moves the powder spreader 419A linearly, transversely to the powder bed 426.

In this embodiment, the powder spreader 419A deposits the powder on the powder bed 426. In some embodiments, the powder spreader 419A comprises features that control the width of the powder distribution area to minimize or prevent powder from falling outside the cylindrical powder bed 426. In other embodiments, the side walls 426C may include flanges that extend into the corners of the powder spreading area, wherein the flanges prevent excess powder from being spread outside the cylindrical powder bed 426.

The powder mover assembly 419B moves the powder spreader 419A linearly with respect to the powder bed 426, while the powder bed 426 and powder depositor 418 are rotating together about the rotation axis 426D. In one embodiment, the powder mover assembly 419B includes a pair of spaced apart actuators 419C (e.g. linear actuators) and a pair of spaced apart linear guides 419D (illustrated in phantom) that move the powder spreader 419A along the Y axis, transversely (perpendicular) to the rotation axis 426D and the powder bed 426. The powder spreader 419A may be moved across the powder bed 426 to the empty “parking space” 419C shown in dotted lines at the top of the FIG. 4.

After the powder spreader 419A is parked at the opposite side of the rotating system, the irradiation device 422 may be energized to selectively melt or fuse the appropriate powder into a solid part 411.

In yet another embodiment, the powder bed 426 may be rectangular and hold a larger volume of powder, but the maximum part volume is confined to a cylindrical volume within the rectangular powder bed 426.

With this design, because the powder bed 426 rotates relative to the irradiation device 422, it is possible to reach every point in the part volume without requiring any acceleration or deceleration time. This feature provides a substantial throughput improvement over prior art systems. Because the only scanning part is the powder spreader 419A with relatively low mass, high acceleration may be used to maintain high throughput.

Moreover, because the powder spreader 419A is moved in a linear fashion relative to the powder bed 426, the powder may be easily distributed in a flat and thin layer. This avoids an excess or lack of powder at the rotation center.

In another embodiment, the processing machine 410 (i) may include more than one irradiation devices 422 and more than one exposure areas (irradiation zones); and/or (ii) multiple parts 411 may be made on the powder bed 426 at one time to increase throughput. For example, the processing machine 410 may include two irradiation devices 422 that define two exposure areas, or three irradiation devices 422 that define three exposure areas.

In certain embodiments, (i) the powder bed 426 and the entire powder depositor 418 are rotating at a substantially constant velocity about the rotation axis 426D relative to irradiation device 422, the pre-heat device, the cooler device, and/or the measurement device, and (ii) the powder depositor 418 is moved linearly, with respect to the powder bed 426 during the powder spreading operation. Alternatively, (i) the powder bed 426 is rotated at a substantially constant velocity relative to the powder depositor 418, irradiation device 422, the pre-heat device, the cooler device, and/or the measurement device about the rotation axis 426D, and (ii) the powder depositor 418 is moved linearly relative to the irradiation device 422, the pre-heat device, the cooler device, and/or the measurement device during the powder spreading operation.

Further, in yet another embodiment, (i) the powder bed 426 is stationary, (ii) the irradiation device 422, the pre-heat device, the cooler device, and/or the measurement device are rotated relative the powder bed 426 about the rotation axis 426D, and (iii) the powder depositor 418 is moved linearly, transversely to the rotation axis 426D, with respect to the stationary powder bed 426 during the powder spreading operation.

In certain embodiments, the powder bed 426 or the top assembly is continuously moved along the Z axis while printing to maintain a substantially constant height. Alternatively, the powder bed 426 or the top assembly may be moved in a stepped like fashion along the Z axis. As another alternative, the powder bed 426 or the top assembly may be ramped down gradually to the next print level.

The embodiments in which the powder bed 426 is stationary and the top assembly is rotated may have the following benefits: (i) eliminate centrifugal forces on the melted metal and the dry powder at the surface, and, below the printing surface, on the powder bed's varied mixture of unused powder and parts in progress; (ii) eliminating the Z-stepping of the powder bed leaves the powder/melted metal/parts agglomeration truly undisturbed; (iii) Z-movement control may be easier with the much lighter and constant-mass top assembly than with the massive and growing powder bed; (iv) the top assembly could finish one complete rotation, then do nothing for 20 degrees of rotation, then start a new layer: this would distribute and perhaps average out any discontinuities or metallurgical differences at the stepping point, and each layer would start 20 degrees farther on, for example; (v) easier cooling system connections to the powder bed, if any are required; (vi) reduce controls complexity for the rotating part and Z-movement: a rotating powder bed is constantly gaining mass, but it needs a steady rotational speed and a steady Z-movement (or a uniform Z-step distance), so the control system has to adjust for that; (vii) a rotating top assembly is far lighter and of roughly constant mass (depending on whether powder replenishment is continuous or periodic); (viii) possibly simplify measurement system because everything is measured against the fixed floor of the powder bed 426. In one embodiment, wireless communications and batteries may be used in the rotating top assembly. Further, printing could pause periodically to replenish power (via capacitors) and powder. Alternatively, if a pause would introduce build discontinuities, then continuous printing could be performed, and electricity might be supplied by continuous inductive charging or another non-contact method, and the powder hopper could be continuously replenished.

As provided above, in one embodiment, the powder bed 426 is moved along the rotation axis 426D, and the top assembly is rotated about the rotation axis 426D at a constant angular velocity. If the powder bed 426 is moved along the rotation axis 426D at a constant speed, the relative motion between the powder bed 426 and the top assembly will be spiral shaped (i.e., helical). In one embodiment, the flat surfaces in the parts 411 may be inclined to match the trajectory of the powder bed 426, or the axis of rotation 426D may be tilted slightly with respect to the Z axis so that the exposure surface of the part 411 is still planar.

In one embodiment, the powder depositor 418 is designed to continuously feed powder to the powder bed 426. In this embodiment, the powder depositor 418 could include a powder hopper (not shown) with a funnel on the rotating top assembly that covers the rotation axis 426D (center zone), and a non-rotating feeder (not shown) (e.g. a screw drive, conveyor belt, etc.) that terminates directly over the funnel. If the center zone is not available due to the needs of other components, then a donut shaped funnel would have one at least one point in its annular opening under a stationary off-axis feeder point at all times. In both of these embodiments it is advantageous to make the large and heavy powder supply mechanism stationary and feed the powder into the rotating top assembly.

If the “melting zone” of each column of the irradiation beam 422D is approximately linear, it may be aligned to the slightly sloped radial surface of a helical surface. It doesn't matter if the helical surface is not planar, as long as it has a sufficiently straight radial line segment. It is also possible that some embodiments may treat a helical powder surface as “approximately flat” since the powder layer thickness is small compared to the part size, the powder bed size, and the energy beam depth of focus.

FIG. 5 is a simplified top view of a portion of still another embodiment of a processing machine 510 for forming the three dimensional part 511. In this embodiment, the processing machine 510 includes (i) the powder bed 526; (ii) the powder depositor 518; and (iii) the irradiation device 522 that are somewhat similar to the corresponding components described above. It should be noted that the processing machine 510 may include the pre-heat device, the cooler device, the measurement device, and the control system, that have been omitted from FIG. 5 for clarity. The powder depositor 518, the irradiation device 522, the pre-heat device, the cooler device, and the measurement device may collectively be referred to as the top assembly.

In the embodiment illustrated in FIG. 5, the powder bed 526 includes a large support platform 527A and one or more build chambers 527B (only one is illustrated) that are positioned on the support platform 527A. In one embodiment, the support platform 527A is holds and supports each build chamber 527B while each part 511 is being built. For example, the support platform 527A may be disk shaped, or rectangular shaped.

In FIG. 5, the build chamber 527B contains the metal powder that is selectively fused or melted according to the desired part geometry. The size, shape and design of the build chamber 527B may be varied. In FIG. 5, the build chamber 527B is generally annular shaped and includes (i) a tubular shaped, inner chamber wall 527C, (ii) a tubular shape, outer chamber wall 527D, and (iii) an annular disk shaped support surface 527E that extends between the chamber walls 527C, 527D.

In this embodiment, the support surface 527E may function as an annular “elevator platform” that may be moved vertically relative to the chamber walls 527C, 527D. In certain embodiments, fabrication begins with the elevator 527E placed near the top of the chamber walls 527C, 527D. The powder depositor 518 deposits a preferably thin layer of metal powder into the build chamber 527B during relative movement between the build chamber 527B and the powder depositor 518. During fabrication of the part 511, the elevator support surface 527E may be slowly lowered down by one layer thickness per revolution so the next layer of powder may be distributed properly in a continuous fashion. In this way, instead of building parts as a stack of thin parallel planar layers, the part(s) are built in a continuous helical layer that spirals on itself many times.

In the embodiment illustrated in FIG. 5, the support platform 527A and the build chamber 527B may be rotated about the rotation axis 526D in the rotation direction 525 at a substantially constant velocity with a mover (not shown) during the manufacturing process relative to at least a portion of the top assembly. Alternatively, at least a portion of the top assembly may be rotated relative to the support platform 527A and the build chamber 527B. Still alternatively, instead of the support surface 527E including the elevator platform that moves down, the support platform 527A may be controlled to move downward along the rotation axis 526D during fabrication and/or the top assembly may be controlled to move upward along the rotation axis 526D during fabrication.

With the present design, the problem of building a practical and low cost three dimensional printer 510 for high volume 3D printing of metal parts 511 is solved by providing a rotating turntable 527A that supports a large annular build chamber 527B suitable for continuous deposition of myriad small parts 511 or individual large parts that fit in the annular region.

In FIG. 5, the irradiation device 522 again includes multiple (e.g. three) separate irradiation energy sources 522C (each illustrated as a circle) that are positioned along the irradiation axis 522B. In this embodiment, the three energy sources 522C are arranged in a line along the irradiation axis 522B so that together they may cover the full radial width of the build chamber 527B. Because the exposure area covers the entire radial dimension of the desired build volume, every point in the required build volume may be reached by at least one of the irradiation beams. Alternatively, a single irradiation energy source 522C may be utilized with a scanning irradiation beam.

As provided herein, this processing machine 510 requires no back and forth motion (no turn motion), so throughput may be maximized. Many parts 511 may be built in parallel in the build chamber 527B. Very large parts that fit within the annular shape may be fabricated. There are many applications that require large round parts with a central hole, so this capability may be valuable in some applications (such as jet engines).

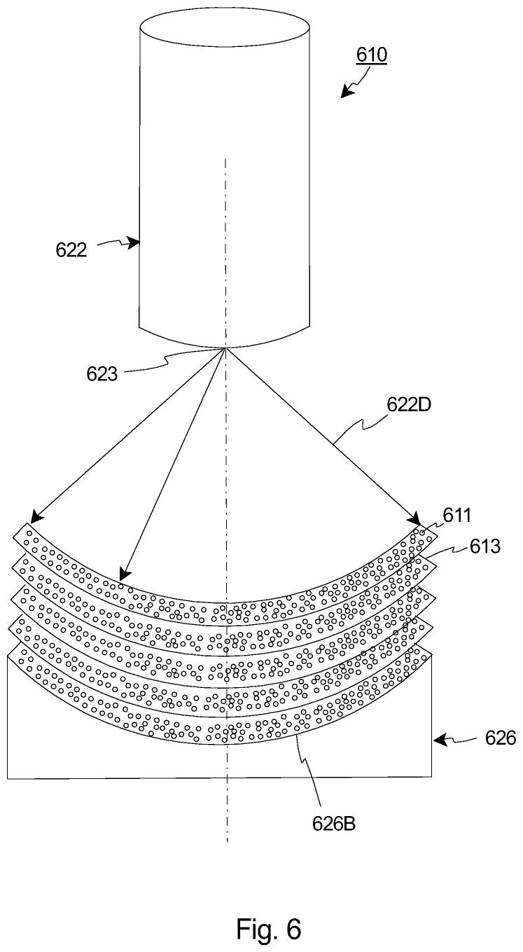

FIG. 6 is a simplified side illustration of a portion of yet another embodiment of the processing machine 610. In this embodiment, the processing machine 610 includes (i) the powder bed 626 that supports the powder 611; and (ii) the irradiation device 622. It should be noted that the processing machine 610 may include the powder depositor, pre-heat device, the cooler device, the measurement device, and the control system, that have been omitted from FIG. 6 for clarity. The powder depositor, the irradiation device 622, the pre-heat device, the cooler device, and the measurement device may collectively be referred to as the top assembly.

In this embodiment, the irradiation device 622 generates the irradiation energy beam 622D to selectively heat the powder 611 in each subsequent powder layer 613 to form the part. In the embodiment of FIG. 6, the energy beam 622D may be selectively steered to any direction within a cone shaped workspace. In FIG. 6 three possible directions for the energy beam 622D are represented by three arrows.

Additionally, in FIG. 6, the support surface 626B of the powder bed 626 is uniquely designed to have a concave, curved shape. As a result thereof, each powder layer 613 will have a curved shape.

As provided herein scanning the energy beam 622D across a large angle at a planar powder surface would create focus errors because the distance from the deflection center to the powder changes with the cosine of the deflection angle. To avoid focus errors, in one embodiment of the system shown in FIG. 6, the support surface 626B and each powder layer 613 have a spherical shape with the center of the sphere at the center of deflection 623 of the energy beam 622D. As a result thereof, the energy beam 622D is properly focused at every point on the spherical surface of the powder 611, and the energy beam 622D has a constant beam spot shape at the powder layer 613. In FIG. 6, the powder 611 is spread on the concave support surface 626B centered at a beam deflection center 623. For a processing machine 610 having a single irradiation energy source as illustrated in FIG. 6, the powder 611 may be spread over the single concave support surface 626B. Alternatively, for a processing machine 610 having multiple, irradiation energy sources, the powder 611 may optionally be spread on multiple curved surfaces, each centered on the deflection center 623 of the respective energy sources.

For an alternative embodiment of the processing machine 610 that uses linear scanning of the powder bed 626 (or the column) into and out of the page, the curved support surface 626B would be cylindrical shape. Alternatively, for an embodiment where the powder bed 626 is rotated about a rotation axis, the curved surface support surface 626B would be designed to have a spherical shape.

In these embodiments, the size and shape of the curved support surface 626B is designed to correspond to (i) the beam deflection of the energy beam 622D at the top powder layer 613, and (ii) the type or relative movement between the energy beam 622D and the powder layer 613. Stated in another fashion, the size and shape of the curved support surface 626B is designed so that the energy beam 622D has a substantially constant focal distance to the top powder layer 613 during relative movement between the energy beam 622D and the powder layer 613. As used herein the term substantially constant focus distance shall mean variations in the focal distance of less than five percent. In alternative embodiments, the term substantially constant focus distance shall mean the focus distance changes no more than ten, five, four, three, two, or one percent.

In FIG. 6, the problem of building a three dimensional printer 610 with focus variations caused by a large beam deflection angle is solved by providing at least one cylindrical or spherical, bowl-shaped support surface 626B that maintains a constant focal distance for the irradiation energy beam 622D. In other words, the embodiment of the FIG. 6 comprises the support device which includes a non-flat (e.g. the curved) support surface, the powder supply device which supplies the powder to the support device and which forms the curved powder layer, and the irradiation device which irradiates the curved powder layer. In this situation, the irradiation device sweeps the energy beam in at least a swept plane (paper plane of FIG. 6) which includes a swept direction. And the curved support surface includes a curvature in the swept plane. The non-flat support surface may be a part of polygonal shape (a shape made of a plurality of straight lines which cross each other).

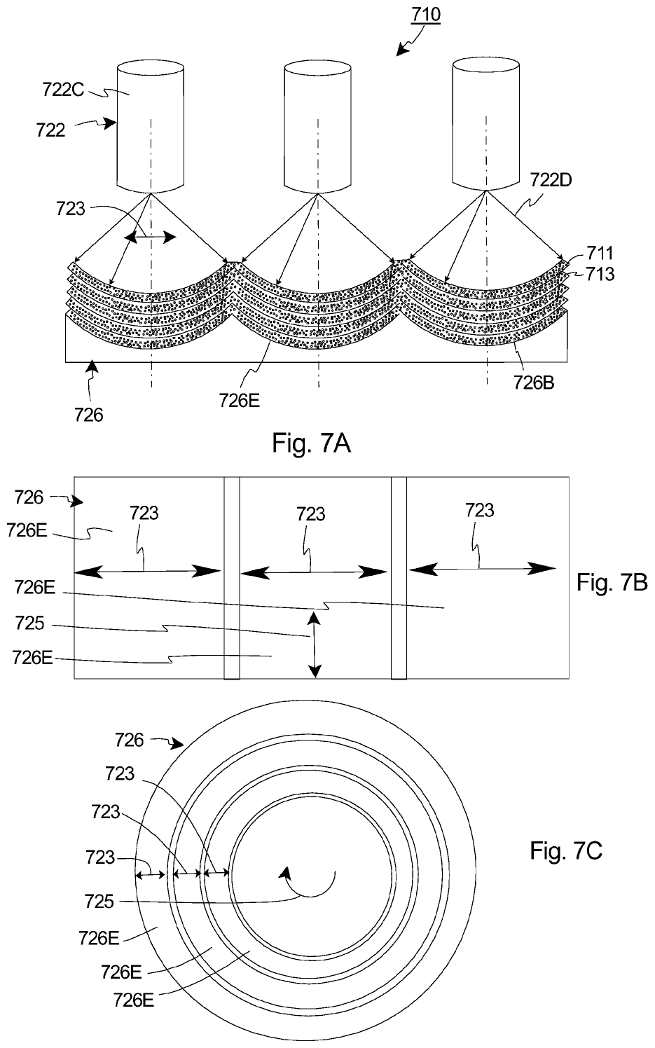

FIG. 7A is a simplified side illustration of a portion of yet another embodiment of the processing machine 710. In this embodiment, the processing machine 710 includes (i) the powder bed 726 that supports the powder 711; and (ii) the irradiation device 722. It should be noted that the processing machine 710 may include the powder depositor, pre-heat device, the cooler device, the measurement device, and the control system, that have been omitted from FIG. 7A for clarity. The powder depositor, the irradiation device 722, the pre-heat device, and the measurement device may collectively be referred to as the top assembly.

In this embodiment, the irradiation device 722 includes multiple (e.g. three) irradiation energy sources 722C that each generates a separate irradiation energy beam 722D that may be steered (scanned) to selectively heat the powder 711 in each subsequent powder layer 713 to form the part. In FIG. 7A, each energy beam 722D may be controllably steered throughout a cone shaped workspace that diverges from the respective energy source 722C. In FIG. 7, the possible directions of each energy beam 722D are each represented by three arrows.

In FIG. 7A, the support surface 726B of the powder bed 726 is uniquely designed to have three concave, curved shaped regions 726E. Stated in another fashion, the support surface 726B includes a separate curved shaped region 726E for each irradiation energy source 722C. As a result thereof, each powder layer 713 will have a dimpled curved shape.

As provided above, scanning each energy beam 722D across a large angle would create focus errors if the surface of the powder 711 were a flat plane because the distance from the deflection center to the powder 711 would change with the cosine of the deflection angle. In the embodiment illustrated in FIG. 7, however, the powder 711 is spread on the three lobed, curved support surface 726B and the distance between the deflection center of each energy beam 722D and the surface of the powder 711 is constant so there are no significant focus errors.

In certain embodiments, such as a system where the powder support surface 726B is rotating in a manner similar to the previously described embodiments, it may be more practical to distribute the powder across a single curved spherical surface. In this case, the columns providing each energy beam 722D may be offset from each other in the vertical direction to more closely align the focal surface of each energy beam 722D with the powder surface. In other words, the shape of the surface of the powder 711 is not precisely matched to the focal distance of each energy beam 722D, but the deviations from optimal focus are small enough with respect to the depth of focus of each energy beam 722D that the proper part geometry may be formed in the powder 711.

The processing machine 710 illustrated in FIG. 7A, may be used with a linear scanning powder bed 726, or a rotating powder bed 726. For a rotating system, it may be preferable to distribute the multiple columns across the powder bed 726 radius, not its diameter. In this case, the powder bed axis of rotation would be at the right edge of the diagrams.

In these embodiments, the size and shape of the curved support regions 726E are designed to correspond to (i) the beam deflection of each energy beam 722D at the top powder layer 713, and (ii) the type of relative movement between the energy beam 722D and the powder layer 713. Stated in another fashion, the size and shape of each curved support region 726E is designed so that the energy beam 722D has a substantially constant focus distance at the top powder layer 713 during relative movement between the energy beam 722D and the powder layer 713. Stated in yet another fashion, the shape of the support region 726E, and the position of the energy beams 722D are linked to the type of relative movement between the support region 726E and the energy beams 722D so that the energy beams 722D have a substantially constant focus distance at the top powder layer 713.

For example, FIG. 7B is a top view of a support bed 726 in which the curved support regions 726E are shaped into linear rows. In this embodiment, there is linear relative movement along a movement axis 725 between the powder bed 726 and the irradiation device 722 (illustrated in FIG. 7A) while maintaining a substantially constant focus distance. A sweep (scan) direction 723 of each beam 722D (illustrated in FIG. 7A) is illustrated with a two headed arrow in FIG. 7B.

Alternatively, for example, FIG. 7C is a top view of a support bed 726 in which the curved support regions 726E are shaped into annular rows. In this embodiment, there is rotational relative movement along a movement axis 725 between the powder bed 726 and the irradiation device 722 (illustrated in FIG. 7A) while maintaining a substantially constant focus distance. A sweep (scan) direction 723 of each beam 722D (illustrated in FIG. 7A) is illustrated with a two headed arrow in FIG. 7C.

As provided herein, maintaining a constant focal distance will improve the part quality by controlling aberrations and the beam spot size.

Referring back FIG. 7A, in this embodiment, (i) the powder bed 726 has a non-flat support region (support surface) 726E, (ii) the powder supply device (not shown in FIG. 7A) supplies the powder 711 to the powder bed 716 to form the curved powder layer 713; and (iii) the irradiation device 722 irradiates the layer 713 with an energy beam 722D to form the built part (not shown in FIG. 7A) from the powder layer 713. In this embodiment, the non-flat support surface 726E may have a curvature. Further, the irradiation device 722 may sweep the energy beam 722D back and forth along a swept direction 723, and wherein the curved support surface 726E includes the curvature in a plane where the energy beam 722D pass through.

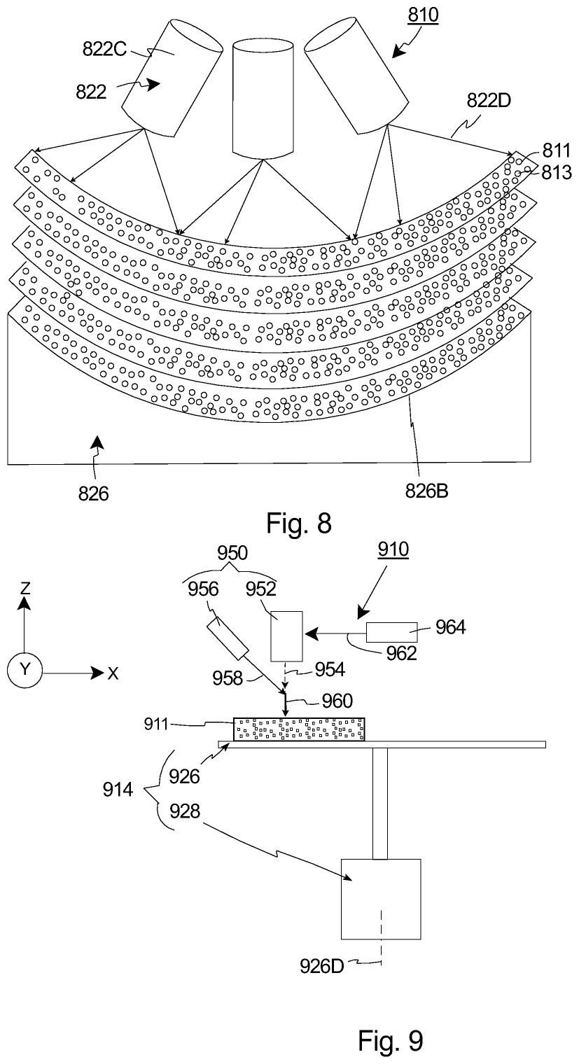

FIG. 8 is a simplified side illustration of a portion of still another embodiment of the processing machine 810. In this embodiment, the processing machine 810 includes (i) the powder bed 826 that supports the powder 811; and (ii) the irradiation device 822 that are somewhat similar to the corresponding components described above and illustrated in FIG. 7A. It should be noted that the processing machine 810 may include the powder depositor, pre-heat device, the cooler device, the measurement device, and the control system, that have been omitted from FIG. 8 for clarity. The powder depositor, the irradiation device 822, the pre-heat device, and the measurement device may collectively be referred to as the top assembly.

In this embodiment, the irradiation device 822 includes multiple (e.g. three) irradiation energy sources 822C that each generates a separate irradiation energy beam 822D that may be steered (scanned) to selectively heat the powder 811 in each subsequent powder layer 813 to form the part. In FIG. 8, each energy beam 822D may be controllably steered throughout a cone shaped workspace that diverges from the respective energy source 822C. In FIG. 8, the possible directions of each energy beam 822D are each represented by three arrows.

In FIG. 8, the support surface 826B of the powder bed 826 is uniquely designed to have large concave curved surface. Stated in another fashion, the support surface 826B is curved shaped.

As provided above, scanning each energy beam 822D across a large angle would create focus errors if the surface of the powder 811 were a flat plane because the distance from the deflection center to the powder 811 would change with the cosine of the deflection angle. In the embodiment illustrated in FIG. 8, however, the powder 811 is spread on the curved support surface 726B, and the irradiation energy sources 822C are tilted relative to each other so that the distance between the deflection center of each energy beam 822D and the surface of the powder 811 is substantially constant so there are no significant focus errors.

In the embodiment illustrated in FIG. 8, the powder support surface 826B is rotating in a manner similar to the previously described embodiments, and the powder 811 is distributed across a single curved spherical surface 826B. In this case, the columns providing each energy beam 822D may be offset from each other in the vertical direction (and angled) to more closely align the focal surface of each energy beam 822D with the powder surface. In other words, the shape of the surface of the powder 811 is not precisely matched to the focal distance of each energy beam 822D, but the deviations from optimal focus are small enough with respect to the depth of focus of each energy beam 822D that the proper part geometry may be formed in the powder 811.

The processing machine 810 illustrated in FIG. 8, may be used with a linear scanning powder bed 826, or a rotating powder bed 826. In these embodiments, the size and shape of the curved support surface 826B is designed and the irradiation energy sources 822C are oriented and positioned (i) so that each energy beam 822D has a substantially constant focus distance at the top powder layer 813, and (ii) to match the type of relative movement between the energy beam 822D and the powder layer 813. Stated in yet another fashion, the shape of the support region 826E, and the position of the energy beams 822D are linked to the type of relative movement between the support region 826E and the energy beams 822D so that the energy beams 822D have a substantially constant focus distance at the top powder layer 813.

FIG. 9 is a simplified side perspective illustration of a portion of yet another embodiment of the processing machine 910 for making a three dimensional part 911. In this embodiment, the processing machine 910 is a wire feed, three dimensional printer that includes (i) the material bed assembly 914 that supports the three dimensional part 911; and (ii) a material depositor 950.

In FIG. 9, the material bed assembly 914 includes the material bed 926 and a device mover 928 that rotates the material bed 926 about the support rotation axis 926D.

Further, in FIG. 9, the material depositor 950 includes (i) an irradiation device 952 that generates an irradiation energy beam 954; and (ii) a wire source 956 that provides a continuous feed of wire 958. In this embodiment, the irradiation energy beam 954 illuminates and melts the wire 958 to form molten material 960 that is deposited onto the material bed 926 to make the part 911.

As provided herein, the problem of manufacturing high precision rotationally symmetric parts 911 by three dimensional printing is solved by using a rotating material bed 926 (build platform), the wire source 956 (wire feed mechanism) that supplies the wire 958, and the irradiation energy beam 954 for melting the wire 958.

In one embodiment, as the material bed 926 is rotated about the rotation axis 926D, the material depositor 950 may provide the molten material 960 to form the part 911. Further, material depositor 950 (irradiation device 952 and wire source 956) may be moved transversely (e.g. along arrow 962) with a depositor mover 964 relative to the rotating material bed 926 to build the part 911. Further, the material bed 926 and/or the material depositor 950 may be moved vertically (e.g. by one of the movers 928, 964) to maintain the desired height between the material depositor 950 and the part 911.

Alternatively, the depositor mover 964 may be designed to rotate the material depositor 950 about a rotation axis and move the material depositor 950 transversely to the rotation axis relative to the stationary material bed 926. Still alternatively, the depositor mover 964 may be designed to rotate the material depositor 950 about a rotation axis relative to the material bed 926, and the material bed 926 may be moved transversely to the rotation axis with the device mover 928.

Round, substantially rotationally symmetric parts 911 may be built by rotating the material bed 926 and depositing metal by using the energy beam 954 to melt the wire feed 958. The basic operation is analogous to a normal metal cutting lathe, except that the “tool” is depositing metal 960 instead of removing it.

Those of ordinary skill in the art will realize that the following detailed description of the present embodiment is illustrative only and is not intended to be in any way limiting. Other embodiments of the present embodiment will readily suggest themselves to such skilled persons having the benefit of this disclosure. Reference will now be made in detail to implementations of the present embodiment as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

1. A processing machine for building a part, the processing machine comprising:
a support device including a support surface;
a drive device which moves the support device so a specific position on the support surface is moved along a moving direction;
a powder supply device which supplies a powder to the moving support device to form a powder layer;
an irradiation device which irradiates at least a portion of the powder layer with an energy beam to form at least a portion of the part from the powder layer during a first period of time; and
a measurement device which measures at least portion of the part during a second period of time,
wherein at least part of the first period in which the irradiation device irradiates the powder layer with the energy beam and at least part of the second period in which the measurement device measures are overlapped.

2. The processing machine of claim 1, wherein the measurement device measures at least a portion of the powder layer during the second period of time.

3. The processing machine of claim 1, wherein the irradiation device sweeps the energy beam along a sweep direction which crosses a moving direction of the support surface.

4. The processing machine of claim 1, wherein a moving direction of the support device includes a rotation direction about a rotation axis.

5. The processing machine of claim 4, wherein the rotation axis passes through the support surface.

6. The processing machine of claim 4, wherein the irradiation device sweeps the energy beam along a direction crossing the rotation direction.

7. The processing machine of claim 4, wherein the irradiation device is arranged at a position away from the rotation axis along an irradiation device direction that crosses the rotation direction.

8. The processing machine of claim 4, wherein the measurement device is arranged at a position away from the rotation axis along a measurement device direction that crosses the rotation direction.

9. The processing machine of claim 8, wherein the irradiation device is arranged at a position which is away from the rotation axis along an irradiation device direction that crosses the rotation direction and which is spaced apart from the measurement device along the rotation direction.

10. The processing machine of claim 1, further comprising
a pre-heat device which pre-heats a powder in a pre-heat zone that is positioned away from an irradiation zone where the energy beam by the irradiation device is directed at the powder along the moving direction.

11. The processing machine of claim 10, wherein the pre-heat device is arranged between the powder supply device and the irradiation device along the moving direction.

12. The processing machine of claim 10, wherein at least part of the first period and at least part of a third period in which the pre-heat device pre-heats the powder are overlapped.

13. The processing machine of claim 10, wherein at least part of the second period and at least part of a third period in which the pre-heat device pre-heats the powder are overlapped.

14. The processing machine of claim 1, wherein the irradiation device including a plurality of irradiation systems which irradiate the powder layer with the energy beam.

15. The processing machine of claim 14, wherein the plurality of irradiation systems are arranged along a direction crossing the moving direction.

16. The processing machine of claim 1, which cools a powder in a cooling zone away from an irradiation zone irradiated with the energy beam by the irradiation device along the moving direction.

17. The processing machine of claim 16, wherein the cooling zone where the powder cools is arranged between the irradiation device and the powder supply device along the moving direction.

18. The processing machine of claim 1, wherein the support surface includes a plurality of support regions.

19. The processing machine of claim 18, wherein the plurality of support regions are arranged along a moving direction.

20. The processing machine of claim 1, wherein
the support surface faces to a first direction, and
the drive device drives the support device so as to move the specific position on the support surface along a second direction crossing at least the first direction.

21. The processing machine of claim 20, wherein the powder supply device forms a layer of a powder along a surface crossing to the first direction.

22. The processing machine of claim 1, wherein at least part of the first period and at least part of a fourth period in which the powder supply device forms the powder layer are overlapped.

23. The processing machine of claim 22, wherein at least part of the fourth period and at least part of a third period in which the pre-heat device pre-heats the powder are overlapped.

24. The processing machine of claim 1, wherein at least part of the second period and at least part of a fourth period in which the powder supply device forms the powder layer are overlapped.

25. The processing machine of claim 1, wherein the irradiation device irradiates the layer with a charged particle beam.

26. The processing machine of claim 1, wherein the irradiation device irradiates the layer with a laser beam.

27. A processing machine comprising:
a support device including a support surface;
a drive device which drives the support device so as to move a specific position on the support surface along a moving direction;
a powder supply device which supplies a powder to the support device which moves, and forms a powder layer; and
an irradiation device which irradiates the layer with an energy beam to form a built part from the powder layer,
wherein the irradiation device changes an irradiation position where the energy beam is irradiated to the powder layer along a direction crossing the moving direction.

28. The processing machine of claim 27, wherein
the drive device drives the support device so as to rotate about a rotation axis, and
the irradiation device changes the irradiation position along a direction crossing the rotation axis.

29. The processing machine of claim 27 wherein at least a portion of the time where powder is supplied and at least a portion of the time where the irradiation beam is irradiated are overlapping.

30. The processing machine of claim 27, wherein at least part of a first period in which the energy beam is irradiating the powder layer and at least part of a second period in which the powder supply device is supplying powder are overlapped.

31. The processing machine of claim 27, further comprising
a pre-heat device which pre-heats a powder in a pre-heat zone that is positioned away from an irradiation zone where the energy beam by the irradiation device is directed at the powder along the moving direction.

32. The processing machine of claim 31, wherein the pre-heat device is arranged between the powder supply device and the irradiation device along the moving direction.

33. The processing machine of claim 31, wherein at least part of a first period in which the energy beam is irradiating the powder layer and at least part of a third period in which the pre-heat device pre-heats the powder are overlapped.

34. The processing machine of claim 31, wherein at least part of a second period in which the powder supply device is supplying powder and at least part of a third period in which the pre-heat device pre-heats the powder are overlapped.

35. The processing machine of claim 27, wherein the irradiation device including a plurality of irradiation systems which irradiate the powder layer with the energy beam.

36. The processing machine of claim 35, wherein the plurality of irradiation systems are arranged along a direction crossing the moving direction.

37. The processing machine of claim 27, which cools a powder in a cooling zone away from an irradiation zone irradiated with the energy beam by the irradiation device along the moving direction.

38. The processing machine of claim 37, wherein the cooling zone where the powder cools is arranged between the irradiation device and the powder supply device along the moving direction.

39. A processing machine comprising:
a support device including a support surface;
a drive device which drives the support device so as to move a specific position on the support surface along a moving direction;
a powder supply device which supplies a powder to the support device which moves, and forms a powder layer; and
an irradiation device including a plurality of irradiation systems which irradiate the layer with an energy beam to form a built part from the powder layer,
wherein the irradiation systems arranged along a direction crossing the moving direction.

40. The processing machine of claim 39, wherein
the drive device drives the support device so as to rotate about a rotation axis, and
the irradiation systems arranged along a direction crossing the rotation axis.

41. An additive manufacturing system for making a three dimensional object from powder, the additive manufacturing system comprising:
a powder bed;
a powder depositor that deposits the powder onto the powder bed; and
a first mover that rotates at least one of the powder bed and the powder depositor about a rotation axis while the powder depositor deposits the powder onto the powder bed.

42. The additive manufacturing system of claim 41 further comprising a second mover that moves at least one of the powder bed and the depositor along the rotation axis while the powder depositor deposits the powder onto the powder bed.

43. The additive manufacturing system of claim 41 further comprising a second mover that moves the powder bed transversely to the rotation axis while the powder depositor deposits the powder onto the powder bed to maintain a substantially constant height between the powder bed and the powder depositor.

44. The additive manufacturing system of claim 41 wherein the first mover rotates the powder bed about the rotation axis relative to the powder depositor while the powder depositor deposits the powder onto the powder bed.

45. The additive manufacturing system of claim 41 further comprising an irradiation device that generates an irradiation beam that is directed at the powder on the powder bed to fuse at least a portion of the powder together to form at least a portion of the three dimensional object, wherein the first mover rotates the powder bed relative to the irradiation device.

46. The additive manufacturing system of claim 41 further comprising an irradiation source that is scanned radially relative to the powder bed.

47. The additive manufacturing system of claim 41 wherein the powder depositor is moved linearly across the rotating powder bed.

48. The additive manufacturing system of claim 41 further comprising a pre-heat device that preheats the powder, and wherein the first mover rotates the powder bed relative to the pre-heat device.

49. The additive manufacturing system of claim 41 wherein the first mover rotates the powder bed at a substantially constant velocity while the powder depositor deposits the powder onto the powder bed.

50. The additive manufacturing system of claim 41 further comprising an irradiation energy source that generates an irradiation beam having shape at the powder bed, wherein the powder bed includes a curved support surface that is curved to correspond to the shape of the irradiation beam at the powder bed.

51. An additive manufacturing system for making a three dimensional object from material, the additive manufacturing system comprising:
a material bed;
a material depositor that deposits molten material onto the material bed to form the object; and
a mover that rotates at least one of the material bed and the material depositor about a rotation axis while the material depositor deposits the molten material onto the material bed.

52. The additive manufacturing system of claim 51 wherein the depositor is a wire feed and energy beam.

53. The additive manufacturing system of claim 52 wherein the energy beam is a charged particle beam.

54. The additive manufacturing system of claim 53 wherein the charged particle beam is an electron beam.

55. The additive manufacturing system of claim 51 where a second mover moves at least one of the material bed and the material depositor in a first direction parallel to the rotation axis.

56. The additive manufacturing system of claim 55 wherein a third mover moves at least one of the material bed and the material depositor in a second direction perpendicular to both the first direction and the rotation axis.

57. A processing machine for building a part, the processing machine comprising:
a support device including a support surface;
a drive device which moves the support device so a specific position on the support surface is moved along a moving direction;
a powder supply device which supplies a powder to the moving support device to form a powder layer during a powder supply time; and
an irradiation device which irradiates at least a portion of the powder layer with an energy beam to form at least a portion of the part from the powder layer during an irradiation time; and
wherein at least part of the powder supply time and the irradiation time are overlapped.

58. The processing machine of claim 57, wherein the irradiation device sweeps the energy beam along a sweep direction which crosses a moving direction of the support surface.

59. The processing machine of claim 57, wherein a moving direction of the support device includes a rotation direction about a rotation axis.

60. The processing machine of claim 59, wherein the rotation axis passes through the support surface.

61. The processing machine of claim 59, wherein the irradiation device sweeps the energy beam along a direction crossing the rotation direction.

62. The processing machine of claim 59, wherein the irradiation device is arranged at a position away from the rotation axis along an irradiation device direction that crosses the rotation direction.

63. The processing machine of claim 59, wherein the measurement device is arranged at a position away from the rotation axis along a measurement device direction that crosses the rotation direction.

64. The processing machine of claim 63, wherein the irradiation device is arranged at a position which is away from the rotation axis along an irradiation device direction that crosses the rotation direction and which is spaced apart from the measurement device along the rotation direction.

65. The processing machine of claim 57, further comprising
a pre-heat device which pre-heats a powder in a pre-heat zone that is positioned away from an irradiation zone where the energy beam by the irradiation device is directed at the powder along the moving direction.

66. A processing machine comprising:
a support device including a non-flat support surface;
a powder supply device which supplies a powder to the support device and which forms a curved powder layer; and
an irradiation device which irradiates the layer with an energy beam to form a built part from the powder layer.

67. The processing machine of claim 66, wherein the non-flat support surface having a curvature.

68. The processing machine of claim 67, wherein the irradiation device sweeps the energy beam along swept direction, and wherein the curved support surface includes a curvature in a plane where the energy beam pass through.
